(19) United States
(12) Patent Application Publication
(10) Pub. No.: US 2005/0029916 A1
(43) Pub. Date: Feb. 10, 2005

(54) Surface conduction electron emission display

(76) Inventor: Seong-Hak Moon, Seoul (KR)

Correspondence Address: BIRCH STEWART KOLASCH & BIRCH, PO BOX 747, FALLS CHURCH, VA, 22040-0747, US

(21) Appl. No.: 10/911,481

(22) Filed: Aug. 5, 2004

(30) Foreign Application Priority Data
Aug. 9, 2003 (KR) 10-2003-0055207

(51) Int. Cl. H01J 1/14; H01J 1/62

(52) U.S. Cl. 313/311; 313/346 R; 313/495

(57) ABSTRACT

A surface conduction electron emission display includes a plurality of pixel cells each consisting of four discharge cells mutually corresponding each other centering around crossings of scan lines and data lines.

### BACKGROUND OF THE INVENTION

1. Field of the Invention

The present invention relates to a surface conduction electron emission display (SED) and, more particularly, to a surface conduction electron emission display capable of enhancing resolution, brightness and contrast.

2. Description of the Background Art

As an information processing system is developed and widely spread, next-generation multimedia displays are increasing in their importance as a visual information transfer means. Currently, a CRT (Cathode Ray Tube) is not suitable for the current trend aiming at large scale flat screen, researches and development are actively ongoing on various flat panel displays (FPD) such as an LCD (Liquid Crystal Display), an FED (Field Emission Display), a PDP (Plasma Display Panel) and an EL (Electro-Luminescence).

Especially, since a product is to be large, flat and light and have low cost and high performance, development of a light, thin and flat display that can substitute the existing CRT is in dire need.

In line with the various requirements, recently, a display using field emission is applied to the display sector, contributing to a thin film display of a compact size with low power consumption providing high resolution, for which developments are pushing ahead.

Among the flat displays, the FED expected to be put to practical use receives much attention as a next-generation telecommunication flat display, because it overcomes shortcomings of the flat displays.

Namely, as a display, the FED has the merits of the CRT in that it has a simple electrode structure, operates at high speed, has high luminance and wide view angle, and the merits of an LCD in that it can be designed to be ultra-thin.

A discharge cell of a general micro-tip type field emission display having such advantages will now be described with reference to FIG. 1.

FIG. 1 is a sectional view showing a discharge cell of the general micro-tip type field emission display.

As shown in FIG. 1, the discharge cell of the general micro-type type field emission display includes a back substrate 20 constructed such that a cathode electrode 18, a dielectric layer 16 and a gate electrode 15 are sequentially stacked on a lower glass substrate 19 and a micro-tip type emitter 17 is formed on the cathode electrode 18, and a front substrate 10 constructed such that an anode electrode 12, phosphor 13 are sequentially stacked on an upper glass substrate.

A spacer 14 is positioned between the front substrate 10 and the back substrate 20, to maintain a distance between the front substrate 10 and the back substrate 20.

The general micro-tip type field emission display has excellent electron emission characteristics with the emitter 17 formed in the micro-tip type, but in order to form a large screen display of 20 inches or wider, the micro-tip type field emission display needs a large-scale fabrication equipment and its fabrication process is complicate, having a low competitive edge compared to other display devices.

An MIM (Metal-Insulator-Metal) type field emission display, which has a simple fabrication process and a structure available for accomplishing a large screen, has been proposed as a substitute for the micro-tip type field emission display. Especially, the surface conduction electron emission display can have high resolution, high luminance and high contrast according to a structure of cells.

The surface conduction electron emission display in accordance with a conventional art will now be described with reference to FIG. 2.

FIG. 2 is a sectional view showing a discharge cell of the surface conduction electron emission display in accordance with a conventional art.

As shown in FIG. 2, a discharge cell of the surface conduction electron emission display includes a back substrate 20 constructed such that a cathode electrode 28 and a gate electrode 25 are stacked side by side on a lower glass substrate 29 and an emitter 27 having a certain gap with a gate electrode 25A is formed on the cathode electrode 28 and the gate electrode 25, and a front substrate 10 constructed such that an anode electrode 12 and phosphor 13 are sequentially stacked on an upper glass substrate 11.

A spacer 14 is positioned between the front substrate 10 and the back substrate 20, to maintain a distance between the front substrate 10 and the back substrate 20.

The operational principle of the discharge cell of the conventional surface conduction electron emission display constructed as described above will now be described in detail.

First, when a certain voltage is applied to the gate electrode 25 and the cathode electrode 28, electrons are emitted from the emitter 27. Namely, electrons are emitted from the emitter 27 toward the gate electrode 25A due to a tunneling effect of quantum mechanics. Herein, the emitter 27 is typically made of PdO and has a certain crack with the gate electrode 25A through a forming process. Electrons are emitted through the certain crack. At this time, if the applied voltage is relatively high, the amount of electrons emitted from the emitter 27 is increased, whereas if the applied voltage is relatively low, the amount of electrons emitted from the emitter 27 would be reduced.

Thereafter, the electrons emitted from the emitter 27 is accelerated toward the anode electrode 12 on which the phosphor 13 has been coated by an influence of electric field formed by a high voltage applied to the anode electrode 12, colliding with the phosphor 13, to generate energy. Electrons existing at the phosphor 13 are excited by the generated energy to emit visible rays.

The structure of the surface conduction electron emission display including such a discharge cell will now be described with reference to FIG. 3.

FIG. 3 is a plan view showing the structure of a surface conduction electron emission display in accordance with a conventional art.

As shown in FIG. 3, in the conventional surface conduction electron emission display, a plurality of scan lines (S1˜Sn) and a plurality of data lines (D1˜Dm) cross each other, and a discharge cell is formed at a portion formed by the crossing, namely, at an upper region of the scan line and left region of the data line. The discharge cells are sequentially arranged at every crossing of the scan line and the data line in order of red (R), green (G) and blue (B), and the sequentially arranged three R, G and B discharge cells constitute one pixel cell.

The scan line means a cathode electrode of the surface conduction electron emission display, and the data line means a gate electrode of the surface conduction electron emission display.

However, the conventional surface conduction electron emission display has a problem that since the discharge cell is formed at every crossing of the scan lines and the data lines and the space taken by one discharge cell is greater than a space taken by the anode electrode, luminance of the surface conduction electron emission display deteriorates.

### SUMMARY OF THE INVENTION

Therefore, one object of the present invention is to provide a surface conduction electron emission display capable of enhancing luminance by forming a plurality of pixel cells each consisting of four mutually corresponding discharge cells centering around a crossing of a scan line and a data line.

Another object of the present invention is to provide a surface conduction electron emission display capable of enhancing resolution by forming a plurality of pixel cells each consisting of four mutually corresponding discharge cells centering around a crossing of a scan line and a data line.

Still another object of the present invention is to provide a surface conduction electron emission display capable of enhancing contrast by forming a plurality of pixel cells each consisting of four mutually corresponding discharge cells centering around a crossing of a scan line and a data line.

To achieve these and other advantages and in accordance with the purpose of the present invention, as embodied and broadly described herein, there is provided a surface conduction electron emission display including a plurality of pixel cells each consisting of four discharge cells mutually corresponding each other centering around crossings of scan lines and data lines

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a discharge cell of a general micro-tip type field emission display;

FIG. 2 is a sectional view showing a discharge cell of a surface conduction electron emission display in accordance with a conventional art;

FIG. 3 is a plan view showing the structure of a surface conduction electron emission display in accordance with the conventional art;

FIG. 4 is a plan view showing the structure of a surface conduction electron emission display in accordance with the present invention;

FIGS. 5A and 5B are sectional views showing the structure of a discharge cell of FIG. 4 in accordance with the present invention;

FIGS. 6A to 6D show various structures of the surface conduction electron emission display in accordance with the present invention;

FIG. 7 is a plan view showing the structure of a surface conduction electron emission display of FIG. 6D in accordance with the present invention; and

FIGS. 8A and 8B are sectional views showing the structure of a discharge cell of FIG. 7 in accordance with the present invention.

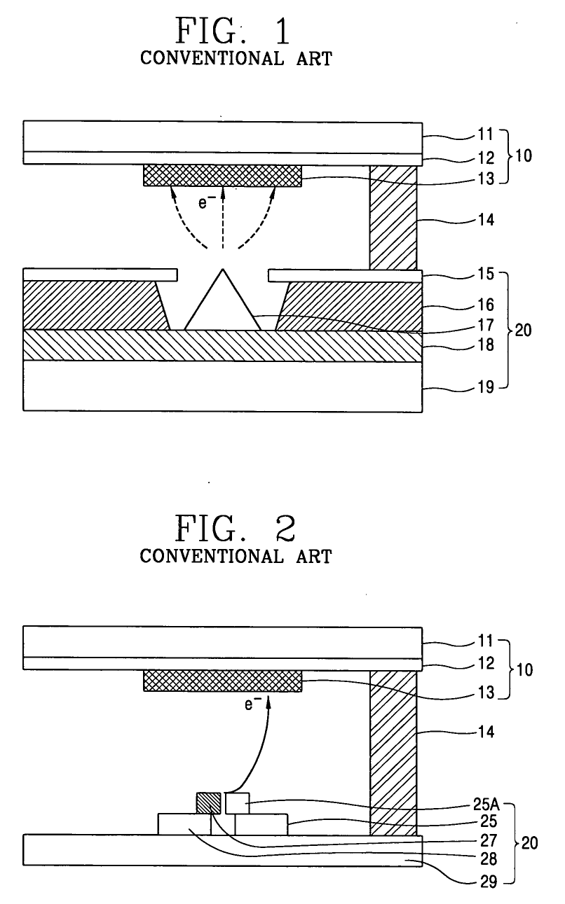

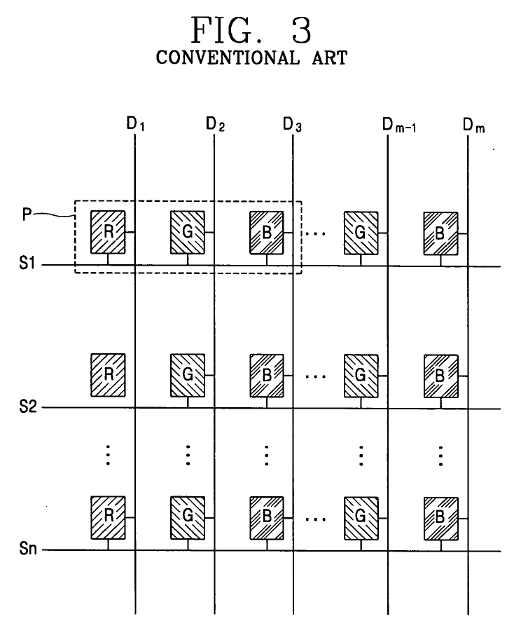

### DETAILED DESCRIPTION OF THE PREFERRED EMBODIMENTS

A surface conduction electron emission display capable of enhancing resolution, brightness and contrast by forming a plurality of pixel cells each consisting of four mutually corresponding discharge cells centering around a crossing of a scan line and a data line, in accordance with a preferred embodiment of the present invention will now be described with reference to the accompanying drawings.

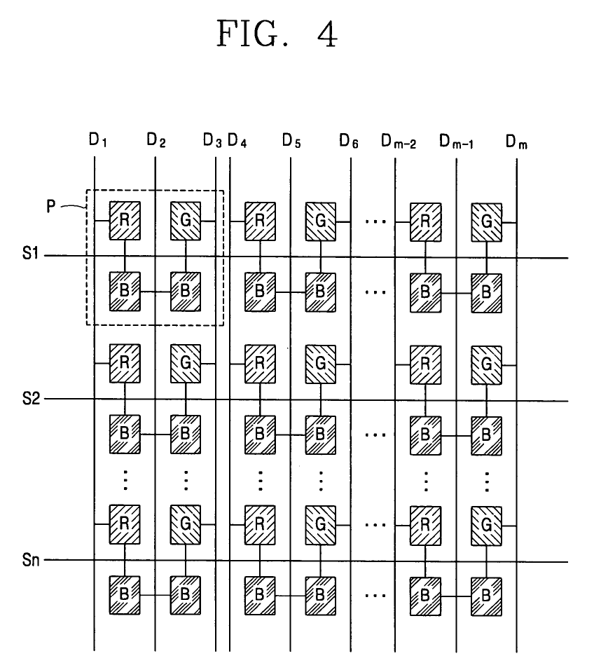

FIG. 4 is a plan view showing the structure of a surface conduction electron emission display in accordance with the present invention.

As shown in FIG. 4, the surface conduction electron emission display in accordance with the present invention is constructed such that a plurality of scan lines S1˜Sn and a plurality of data lines D1˜Dm cross each other and two discharge cells formed at an upper side of the scan liens and two discharge cells formed at a lower side of the scan lines are symmetrical, whereby the plurality of pixel cells each consisting of four discharge cells have a matrix form. Of the four discharge cells, two discharge cells are coated with green (R) and green (G) phosphor and two other discharge cells are coated with blue (B) phosphor.

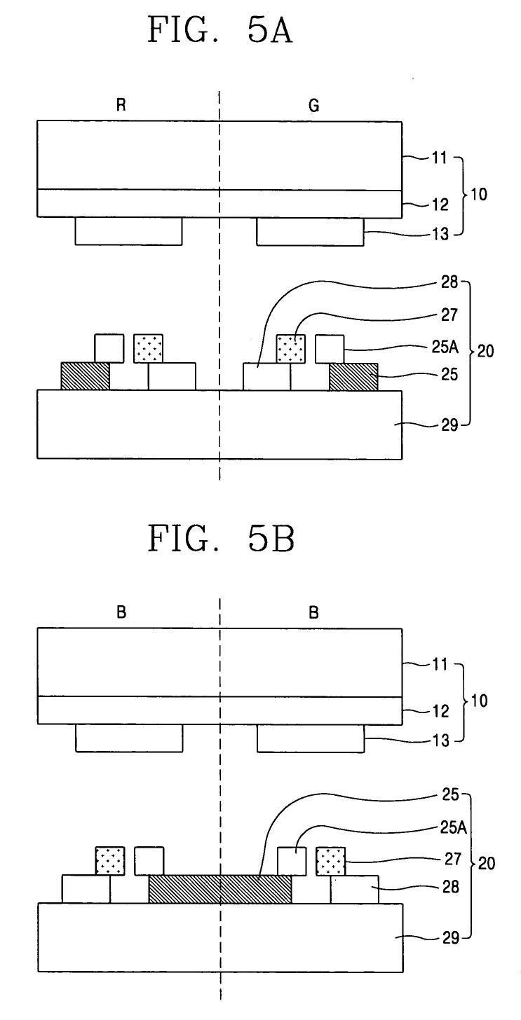

The structure of the discharge cell in accordance with the present invention will be described as follows with reference to FIGS. 5A and 5B.

FIGS. 5A and 5B are sectional views showing the structure of a discharge cell of FIG. 4 in accordance with the present invention.

As shown in FIGS. 5A and 5B, in the surface conduction electron emission display, two discharge cells coated with R and G phosphor are connected to different data electrodes formed at an outer side, and two discharge cells coated with B phosphor are connected to the data electrode formed at the inner side of each cell.

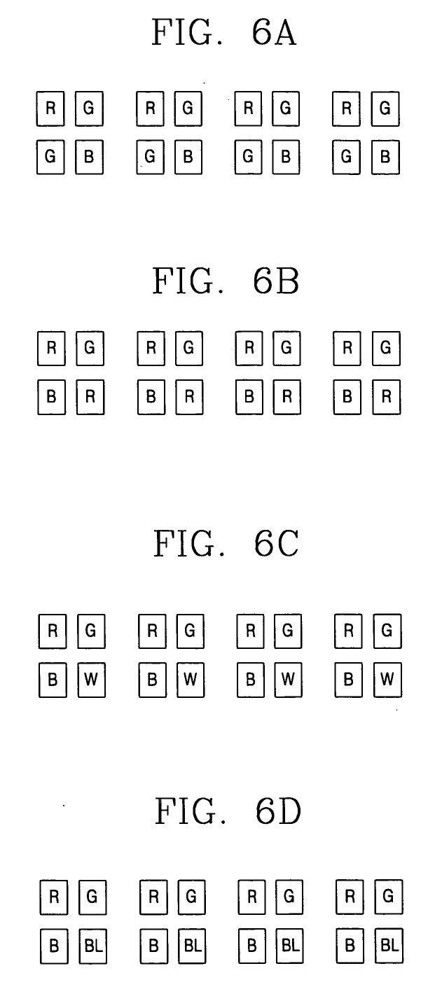

Various other constructions of four discharge cells constituting pixel cells of the surface conduction electron emission display will now be described with reference to FIGS. 6A to 6D.

FIGS. 6A to 6D show various structures of the surface conduction electron emission display in accordance with the present invention.

As shown in FIGS. 6A to 6D, the surface conduction electron emission display can be constructed with three discharge cells coated with the R, G and B phosphor and one discharge cell coated with one of R, G and B phosphor and white and block phosphor.

The construction of the surface conduction electron emission display constructed as described above will now be explained.

First, each pixel cell includes one scan line and three data lines, and four discharge cells which correspond centering around the crossing of the scan line and the data line.

In one pixel cell consisting of four discharge cells in the surface conduction electron emission display, three discharge cells are coated with R, G and B phosphor and the remaining one discharge cell is coated with one of the R, G and B phosphor. Accordingly, the area corresponding to the pixel cell becomes relatively small, and thus, resolution of the surface conduction electron emission display can be enhanced.

For example, the data line (D2) is disposed in the middle of one pixel cell (P) to cross the scan line (S1), so that four discharge cells can correspond each other centering around the crossing. In this case, the data line (D2) provides data signals to the two discharge cells coated with B phosphor, the data line (D3) for providing a data signal to one discharge cell coated with G phosphor and the data line (D1) for providing a data signal to one discharge cell coated with R phosphor are disposed side by side with the data line (D2).

In general, since the discharge cell coated with B phosphor has a low discharge efficiency compared to the discharge cells coated with R and G phosphor, the discharge cells coated with R and G phosphor are formed side by side at the upper side of the scan line of the pixel cells and two discharge cells coated with B phosphor are formed at the lower side of the scan line in order to improve brightness of the surface conduction electron emission display.

Meanwhile, of the four discharge cells, three discharge cells can be coated with R, G and B phosphor and one discharge cell is coated with white (W) phosphor, in order to enhance brightness of the surface conduction electron emission display.

In addition, by coating three discharge cells with R, G and B phosphor and one discharge cell with black (BL) phosphor, contrast of the surface conduction electron emission display can be enhanced.

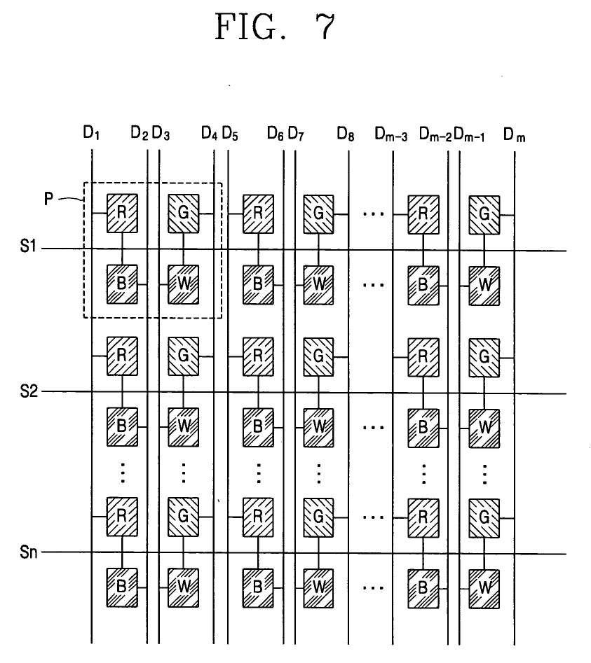

The structure of the surface conduction electron emission display having the discharge cells coated with the W phosphor or BL phosphor will be described with reference to FIG. 7 as follows.

FIG. 7 is a plan view showing the structure of the surface conduction electron emission display of FIG. 6D in accordance with the present invention.

As shown in FIG. 7, in case that one pixel cell consists of three discharge cells coated with R, G and B phosphor and one discharge cell coated with W phosphor or BL phosphor, a data line is additionally formed at the central position of the pixel cell.

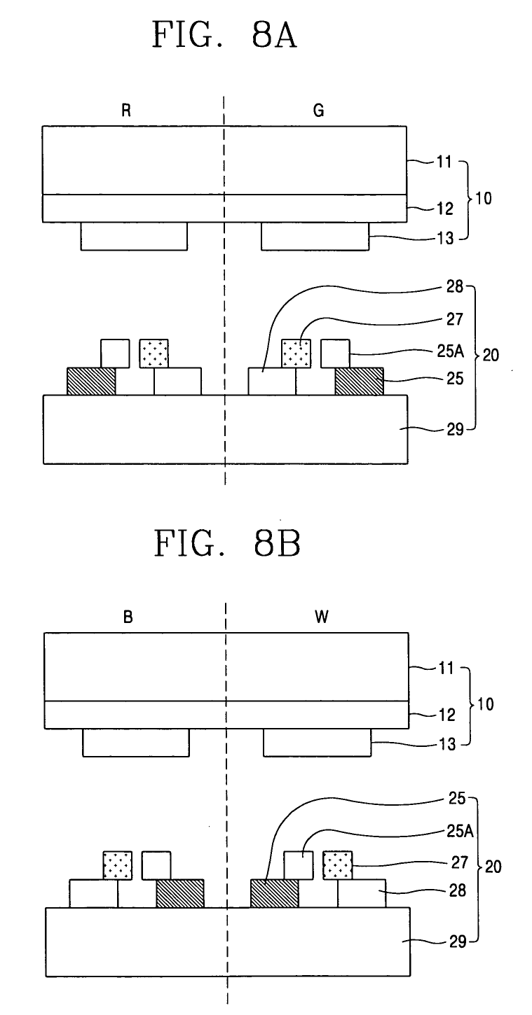

The structure of the discharge cell of the surface conduction electron emission display constructed as described above will now be described in detail with reference to FIG. 8.

FIGS. 8A and 8B are sectional views showing the structure of the discharge cell of FIG. 7 in accordance with the present invention.

As shown in FIG. 8, in the surface conduction electron emission display, two discharge cells coated with R and G phosphor are connected to different data electrodes respectively formed at outer sides of cells, and two discharge cells coated with B and W phosphor are connected to different data electrodes formed at the inner side of the cells.

In this manner, the pixel cell can be constructed variably with the three discharge cells coated with R, G and B phosphor and one discharge cell coated with one of R, G and B phosphor, white and black phosphor.

As so far described, the surface conduction electron emission display in accordance with the present invention has many advantages.

That is, for example, since the plurality of pixel cells are formed to respectively have four discharge cells corresponding each other centering around crossings of scan lines and data lines, the area of the pixel cell is relatively reduced, and thus, resolution of the surface conduction electron emission display can be improved.

In addition, since the plurality of pixel cells are formed to respectively have four discharge cells corresponding each other centering around crossings of scan lines and data lines and black phosphor is coated, brightness of the surface conduction electron emission display can be improved.

Moreover, since the plurality of pixel cells are formed to respectively have four discharge cells corresponding each other centering around crossings of scan lines and data lines and white phosphor is coated, contrast of the surface conduction electron emission display can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A surface conduction type electron emission display comprising:
a plurality of pixel cells each consisting of four discharge cells mutually corresponding each other centering around crossings of scan lines and data lines.

2. The display of claim 1, wherein the pixel cell includes one scan line and a plurality of data lines.

3. The display of claim 2, wherein the pixel cells includes either three or four data lines.

4. The display of claim 1, wherein the discharge cells are symmetrical vertically centering on the scan line and symmetrical horizontally centering on the data line.

5. The display of claim 1, wherein the pixel cell includes three different data lines to provide data signals to discharge cells coated with R (red), G (green) and B (blue) phosphor.

6. The display of claim 5, wherein the discharge cells include three discharge cells coated with R, G and B phosphor and one discharge cell coated with one of R, G and B phosphor.

7. The display of claim 6, wherein the discharge cells include two discharge cells coated with R phosphor and two discharge cells coated with G and B phosphor.

8. The display of claim 6, wherein the discharge cells include two discharge cells coated with G phosphor and two discharge cells coated with R and B phosphor.

9. The display of claim 6, wherein the discharge cells include two discharge cells coated with B phosphor and two discharge cells coated with R and G phosphor.

10. The display of claim 5, wherein the discharge cells include three discharge cells coated with R, G and B phosphor and one discharge cell coated with one of white and block phosphor.

11. The display of claim 10, wherein the discharge cells include three discharge cells coated with R, G and B phosphor and one discharge cell coated with white phosphor.

12. The display of claim 11, wherein each pixel cell includes one additional data line for providing data signals to one discharge cell coated with white phosphor.

13. The display of claim 10, wherein the discharge cells include three discharge cells coated with R, G and B phosphor and one discharge cell coated with black phosphor.

14. The display of claim 13, wherein each pixel cell includes one additional data line for providing data signals to one discharge cell coated with black phosphor.
